(19) United States
(12) Patent Application Publication
(10) Pub. No.: US 2025/0282162 A1
(43) Pub. Date: Sep. 11, 2025

(54) INK JET RECORDING APPARATUS

(71) Applicant: CANON KABUSHIKI KAISHA, Tokyo (JP)

(72) Inventor: TAKAAKI DOSHIDA, Tokyo (JP)

(21) Appl. No.: 19/064,100

(22) Filed: Feb. 26, 2025

(30) Foreign Application Priority Data
Mar. 8, 2024 (JP) 2024-035942

(51) Int. Cl. B41J 29/377; B41J 11/00; B41J 29/13

(52) U.S. Cl. CPC B41J 29/377; B41J 11/0022; B41J 11/0024; B41J 11/007; B41J 11/0095; B41J 29/13

(57) ABSTRACT

An ink jet recording apparatus includes a conveyance portion, a drying portion including a heater and a blowing fan, a casing, a temperature sensor, an exhaust fan configured to exhaust air in the casing, a door provided to be opened and closed on the casing, a lock mechanism configured to lock the door to the casing in a closed state, and a control portion. In a case where the control portion receives an instruction to unlock the door locked by the lock mechanism, the control portion is configured to stop heating of the air by the heater, start an operation of the exhaust fan when the exhaust fan is stopped, continue the operation of the exhaust fan when the exhaust fan is in operation, and unlock the door locked by the lock mechanism after the temperature in the casing reaches a predetermined temperature or lower.

### BACKGROUND OF THE INVENTION

### Field of the Invention

The present invention relates to an ink jet recording apparatus that forms an image by ink.

### Description of the Related Art

In the related art, an ink jet recording apparatus that forms an image on a recording material by ink has been proposed. The ink jet recording apparatus described in Japanese Patent Application Laid-Open Publication No. 2023-60712 includes a drying portion that blows high-temperature air to a recording material on which an image is formed by ink to dry the recording material (Japanese Patent Application Laid-Open Publication No. 2023-60712). In the drying portion, the recording material is dried by blowing high-temperature air to the recording material conveyed on a rotating conveyor belt.

In the ink jet recording apparatus, a door that can be opened and closed is disposed in a casing so that a user can perform maintenance and the user can remove a clogged recording material in a case where a so-called jam occurs in which the recording material is clogged in the middle of being conveyed. However, the door is locked not to be opened unless the user issues an unlocking instruction to open the door.

### SUMMARY OF THE INVENTION

According to a first aspect of the present invention, an ink jet recording apparatus forming an image on a recording material by jetting an ink, the apparatus includes a conveyance portion configured to convey the recording material on which the image is formed by the ink, a drying portion including a heater and a blowing fan blowing air toward the conveyance portion and configured to dry the ink by blowing air heated by the heater to the recording material conveyed by the conveyance portion, a casing configured to accommodate the conveyance portion, a temperature sensor configured to detect a temperature in the casing, an exhaust fan configured to exhaust air in the casing to an outside of the casing and to be controlled to an operation state and a stop state based on a detection result of the temperature sensor, a door provided to be opened and closed on the casing to allow access to the conveyance portion, a lock mechanism configured to lock the door to the casing in a closed state, and a control portion configured to control the drying portion, the lock mechanism, and the exhaust fan. In a case where the control portion receives an instruction to unlock the door locked by the lock mechanism, the control portion is configured to stop heating of the air by the heater, start an operation of the exhaust fan when the exhaust fan is stopped, continue the operation of the exhaust fan when the exhaust fan is in operation, and unlock the door locked by the lock mechanism after the temperature in the casing reaches a predetermined temperature or lower.

According to a second aspect of the present invention, an ink jet recording apparatus forming an image on a recording material by jetting an ink, the apparatus includes a conveyance portion configured to convey the recording material on which the image is formed by the ink, a detection unit configured to detect the recording material conveyed by the conveyance portion, a drying portion including a heater and a blowing fan blowing air toward the conveyance portion and configured to dry the ink by blowing air heated by the heater to the recording material conveyed by the conveyance portion, a casing configured to accommodate the conveyance portion, a temperature sensor configured to detect a temperature in the casing, an exhaust fan configured to exhaust air in the casing to an outside of the casing and to be controlled to an operation state and a stop state based on a detection result of the temperature sensor, a door that is provided to be opened and closed on the casing to allow access to the conveyance portion, a lock mechanism configured to lock the door to the casing in a closed state, and a control portion configured to control the drying portion, the lock mechanism, and the exhaust fan. In a case where an error occurs in a detection result of the detection unit, the control portion is configured to stop heating of the air by the heater, and start the operation of the exhaust fan when the exhaust fan is stopped. When the control portion receives an instruction to unlock the door locked by the lock mechanism after the error occurs, the control portion is configured to unlock the door locked by the lock mechanism after the temperature in the casing reaches a predetermined temperature or lower.

Further features of the present invention will become apparent from the following description of exemplary embodiments with reference to the attached drawings.

### BRIEF DESCRIPTION OF THE DRAWINGS

FIG. 1 is a schematic view showing an ink jet recording apparatus.

FIG. 2A is a front view showing a drying module.

FIG. 2B is a right side view showing the drying module.

FIG. 2C is a schematic view.

FIG. 3 is a schematic view showing a configuration of the drying module.

FIG. 4 is a cross-sectional view showing a hot air blowing unit.

FIG. 5 is a control block diagram showing a control system of the drying module.

FIG. 6 is a flowchart showing door unlocking processing of a first embodiment.

FIG. 7 is a flowchart showing door unlocking processing according to a second embodiment.

### DESCRIPTION OF THE EMBODIMENTS

### First Embodiment

### Ink Jet Recording Apparatus

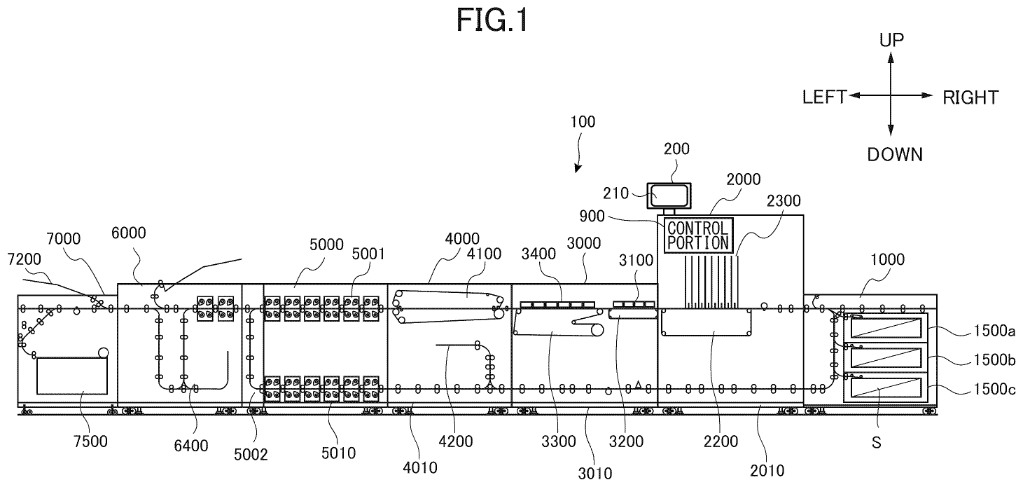

Hereinafter, embodiments of the present invention will be described with reference to drawings. First, an ink jet recording apparatus of the present embodiment will be described with reference to FIG. 1. An ink jet recording apparatus 100 of the present embodiment is a so-called sheet-fed ink jet recording apparatus that forms an image on a recording material by using an ink and a reaction solution based on image information input from an external apparatus such as a computer or a document reading apparatus. The recording material may be, for example, a recording material capable of receiving ink, such as paper such as plain paper and cardboard, plastic film such as a recording material for overhead projectors, specially shaped recording materials such as envelopes and index paper, and cloth.

In the present specification, a side on which the user stands when operating the ink jet recording apparatus 100 is referred to as a “front (or front side)”, and an opposite side thereof is referred to as a “rear (or rear side)”. In addition, the left side when viewed from the front is referred to as “left”, and the right side when viewed from the front is referred to as “right”. FIG. 1 shows a case where the ink jet recording apparatus 100 is viewed from the front.

As shown in FIG. 1, the ink jet recording apparatus 100 includes a feeding module 1000, a printing module 2000, a drying module 3000, a fixing module 4000, a cooling module 5000, a reverse module 6000, and a loading module 7000. A recording material S supplied from the feeding module 1000 is subjected to various types of processing while being conveyed along the conveyance path in each module, and is finally discharged to the loading module 7000.

The feeding module 1000, the printing module 2000, the drying module 3000, the fixing module 4000, the cooling module 5000, the reverse module 6000, and the loading module 7000 may each have a separate casing, and the ink jet recording apparatus 100 may be configured by connecting the casings. For example, a casing 2010 of the printing module 2000 and a casing 3010 of the drying module 3000, the casing 3010 and a casing 4010 of the fixing module 4000, and the casing 4010 and a casing 5010 of the cooling module 5000 are connected to each other so that the recording material S can be transferred between the respective casings. In the present embodiment, the feeding module 1000, the printing module 2000, the drying module 3000, the fixing module 4000, the cooling module 5000, the reverse module 6000, and the loading module 7000 may be disposed in one casing.

The feeding module 1000 includes cassettes 1500a, 1500b, and 1500c that accommodate the recording material S, and the cassettes 1500a to 1500c are provided to be pulled out to the front side in order to accommodate the recording material S. The recording material S is fed one by one by a separation belt and a conveyance roller in each of the cassettes 1500a to 1500c, and is conveyed to the printing module 2000.

The printing module 2000 includes a pre-imaging conveyance unit (not shown), a printing belt unit 2200, and a recording portion 2300. The recording material S conveyed from the feeding module 1000 is conveyed to the printing belt unit 2200 after the inclination or position of the recording material S is corrected by the pre-imaging conveyance unit. The recording portion 2300 is disposed at a position facing the printing belt unit 2200 with respect to the conveyance path of the recording material S. The recording portion 2300 forms an image by jetting ink onto the recording material S by a plurality of recording heads from above the recording material S conveyed by the belt. The recording material S is suctioned and conveyed by the printing belt unit 2200 to ensure clearance with the recording heads.

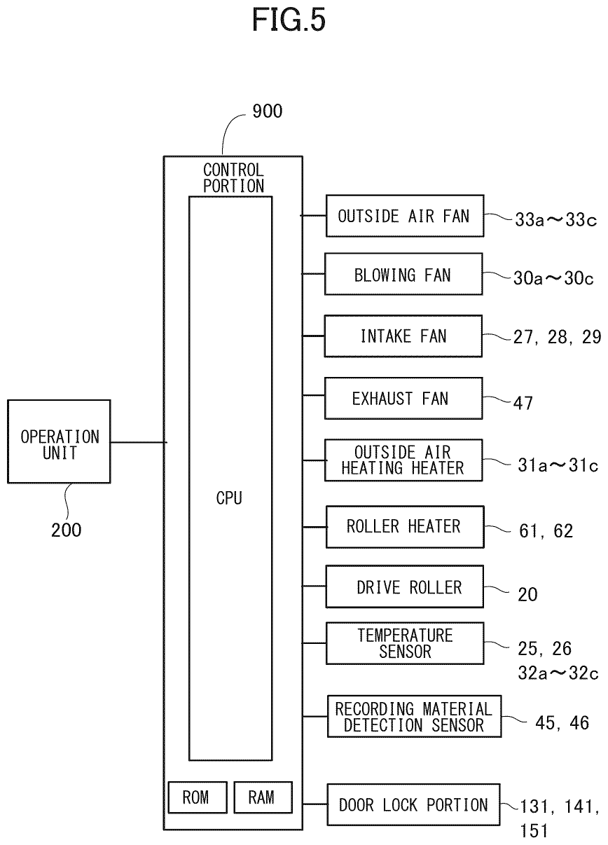

In addition, the printing module 2000 includes a control portion 900, and the control portion 900 controls the entire ink jet recording apparatus 100. The control portion 900 has, for example, a central processing unit (CPU), a read only memory (ROM), and a random access memory (RAM) (see FIG. 5). Various programs such as an image forming job and various types of data such as image data are stored in the ROM or the RAM. For example, the CPU can operate the ink jet recording apparatus 100 to perform image formation by executing an image forming program stored in the ROM or the RAM. The RAM can temporarily store, for example, a calculation processing result obtained by executing various programs.

Further, the printing module 2000 is provided with an operation unit 200. The operation unit 200 includes a liquid crystal display unit 210 that can display various types of information in addition to physically provided switches. The liquid crystal display unit 210 shows various programs, various types of data, or various displays such as the end of an image forming job or the occurrence of a jam caused by the recording material S being clogged in the middle of being conveyed. The operation unit 200 may be a touch panel that can receive, for example, a start input of various programs such as an image forming job, inputs of various types of data, or an instruction to unlock the door described below in response to a touch operation of the user. The start input of the various programs, the inputs of various types of data, an instruction to unlock the door, and the like are not limited to be input from the operation unit 200, and may be input from an external apparatus such as a computer.

The image forming job is a series of operations from the start of image formation to the completion of the image forming operation based on the image signal for forming an image on the recording material S. That is, the image forming job is a series of operations from the start of a preliminary operation (so-called previous rotation) required for performing image formation to the completion of a preliminary operation (so-called subsequent rotation) required for completing the image formation through an image forming step. Specifically, the image forming job refers to a period from a previous rotation after receiving the image signal (preparatory operation before image formation) to a subsequent rotation (operation after image formation), and includes an image formation period and a paper gap.

The drying module 3000 has an outside air blowing unit 3100, a decoupling portion 3200, a drying belt unit 3300, and a hot air blowing unit 3400. The drying module 3000 reduces the liquid component of the ink applied to the recording material S in order to increase the fixing property of the ink to the recording material S by the subsequent fixing module 4000.

The recording material S on which an image is formed is conveyed to the decoupling portion 3200 disposed in the drying module 3000. In the decoupling portion 3200, a frictional force is generated between the recording material S and the belt by the wind pressure of the air blown from the outside air blowing unit 3100 disposed above the decoupling portion 3200, and the recording material S is conveyed by the belt. In this way, the recording material S placed on the belt is conveyed by the frictional force, and thus the recording material S is prevented from deviating during the conveyance of the recording material S over the printing belt unit 2200 and the decoupling portion 3200.

The recording material S conveyed from the decoupling portion 3200 is conveyed by the drying belt unit 3300 serving as a conveyance portion. The hot air blowing unit 3400 is disposed above the drying belt unit 3300, and hot air heated by a heater to a high temperature is blown from the hot air blowing unit 3400 serving as a drying portion to the recording material S conveyed from the drying belt unit 3300. In this manner, the ink applied to the recording material S is dried.

The fixing module 4000 includes a fixing belt unit 4100. The fixing belt unit 4100 fixes the ink to the recording material S by causing the recording material S conveyed from the drying module 3000 to pass between the heated upper belt unit and the lower belt unit.

The cooling module 5000 has a plurality of cooling portions 5001 and cools the recording material S having a high temperature conveyed from the fixing module 4000 by the cooling portions 5001. Although the cooling portion 5001 is not shown, the cooling portion 5001 takes in air (outside air) into a cooling box by a fan from the outside of the casing 5010 to increase the pressure in the cooling box, and applies air, which is ejected from the cooling box through a nozzle by the pressure, to the recording material S to cool the recording material S. The cooling portions 5001 are disposed on both sides of the recording material S in the conveyance path of the recording material S, and cools both sides of the recording material S.

In addition, the cooling module 5000 is provided with a conveyance path switching portion 5002. The conveyance path switching portion 5002 switches the conveyance path of the recording material S according to whether the recording material S is conveyed to the reverse module 6000 or whether the recording material S is conveyed to the double-sided conveyance path for double-sided printing, in which images are formed on both sides of the recording material S.

The reverse module 6000 includes a reverse portion 6400. The reverse portion 6400 reverses the front and back of the recording material S to be conveyed and changes the front and back orientation of the recording material S when discharging the recording material S to the supporting module 7000. The supporting module 7000 has a top tray 7200 and a supporting portion 7500, and supports the recording material S conveyed from the reverse module 6000.

In a case of double-sided printing, the recording material S is conveyed to a conveyance path below the cooling module 5000 by the conveyance path switching portion 5002. Thereafter, the recording material S is returned to the printing module 2000 through the double-sided conveyance path of the fixing module 4000, the drying module 3000, the printing module 2000, and the feeding module 1000. The double-sided conveyance portion of the fixing module 4000 is provided with a reverse portion 4200 that reverses the front and back of the recording material S. The recording material S returned to the printing module 2000 has an image formed by ink on the other side on which an image is not formed, and is discharged to the supporting module 7000 through the drying module 3000, the fixing module 4000, the cooling module 5000, and the reverse module 6000.

### Drying Module

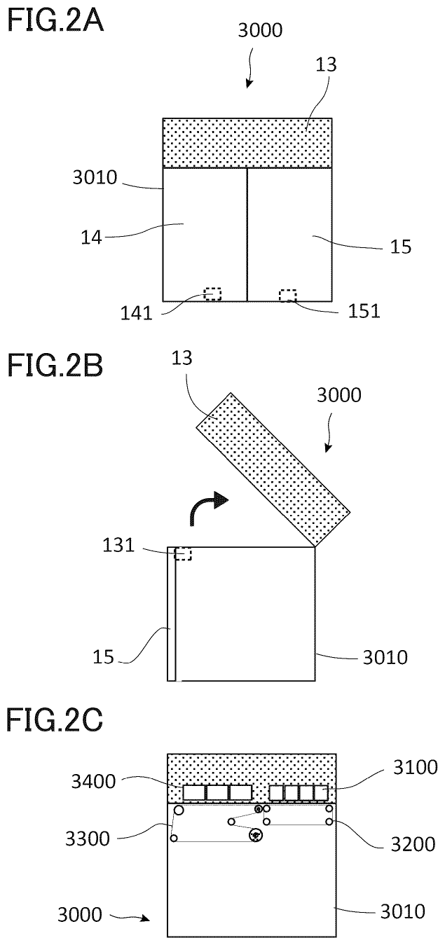

Next, the drying module 3000 will be described with reference to FIGS. 2A to 4. As shown in FIG. 2A, a left front door 14, a right front door 15, and an upper door 13 are disposed to be opened and closed on the casing 3010 of the drying module 3000. The left front door 14 is provided to be pivotable about a pivot shaft provided on a left side of the casing 3010 serving as a pivot axis, and the right front door 15 is provided to be pivotable about a pivot shaft provided on a right side of the casing 3010 serving as a pivot axis. That is, the left front door 14 and the right front door 15 are double doors that are opened and closed in a direction intersecting the casing 3010 in the up-down direction.

As shown in FIG. 2B, the upper door 13 is provided to be pivotable about a pivot shaft provided on the rear side of the casing 3010 serves as a pivot axis. That is, by supporting the upper door 13 to be pivotable on the rear side, the front side of the upper door 13 can be opened upward so that the user can easily work from the front. As shown in FIG. 2C, the outside air blowing unit 3100 and the hot air blowing unit 3400 are attached to the upper door 13, and the outside air blowing unit 3100 and the hot air blowing unit 3400 are moved integrally with the upper door 13. In this case, the decoupling portion 3200 and the drying belt unit 3300 remain on the casing 3010 side. In the present specification, the left front door 14 and the right front door 15 to which the unit is not attached unlike the upper door 13, and the upper door 13 to which the outside air blowing unit 3100 and the hot air blowing unit 3400 are attached are referred to as “door”. Among these doors, the left front door 14 and the upper door 13 are doors that are provided to be opened and closed in the casing 3010 in order to allow access to the drying belt unit 3300 accommodated in the casing 3010.

The user can perform maintenance on the outside air blowing unit 3100, the decoupling portion 3200, the drying belt unit 3300, and the hot air blowing unit 3400 in the casing 3010 by opening the upper door 13, the left front door 14, and the right front door 15. In addition, the user can remove the recording material S from the decoupling portion 3200 or the drying belt unit 3300 by opening the upper door 13, the left front door 14, and the right front door 15 when a jam occurs.

The drying module 3000 is provided with door lock portions (131, 141, and 151) serving as lock mechanisms that can lock the upper door 13, the left front door 14, and the right front door 15, respectively. When the main power supply of the ink jet recording apparatus 100 is turned on, the door lock portion 131, the door lock portion 141, and the door lock portion 151 lock the upper door 13, the left front door 14, and the right front door 15, respectively, in a closed state not to be opened. The locked state of each door by the door lock portions (131, 141, and 151) is unlocked by the door unlocking based on the unlocking signal transmitted from the control portion 900 in response to the user's instruction to unlock the door from the operation unit 200. The door lock portions (131, 141, and 151) are not shown, but each of the door lock portions has, for example, a locking claw that is provided to be pivotable and a motor or the like that causes the locking claw to pivot. The control portion 900 controls the motor to pivot the locking claw.

### Decoupling Portion

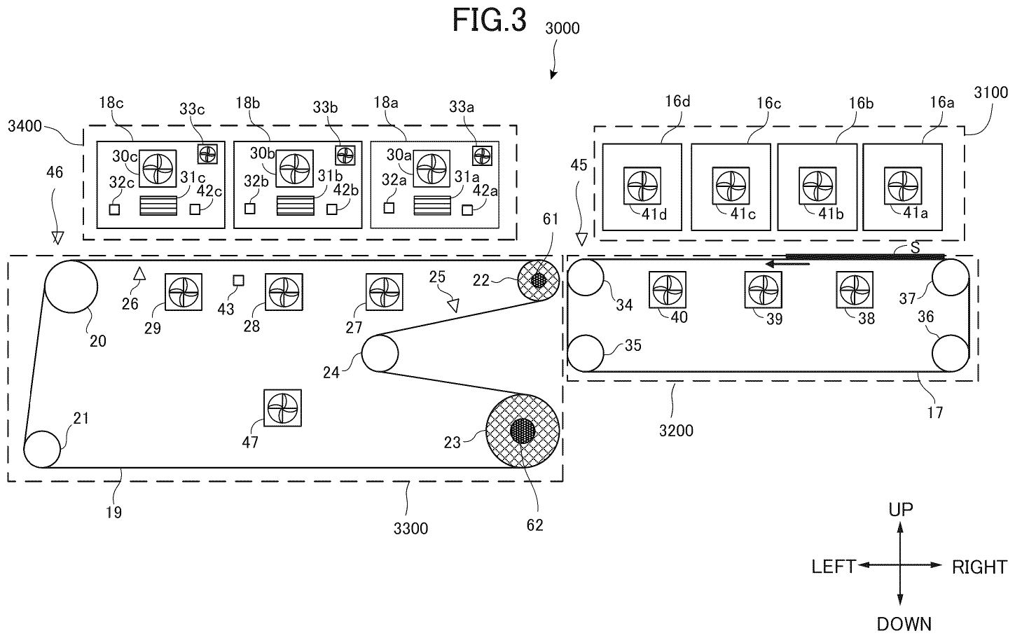

The outside air blowing unit 3100, the decoupling portion 3200, the drying belt unit 3300, and the hot air blowing unit 3400 of the drying module 3000 will be described in detail. As shown in FIG. 3, the decoupling portion 3200 includes an endless conveyor belt 17, a drive roller 34, driven rollers 35, 36, and 37, and fans 38, 39, and 40. The conveyor belt 17 is stretched around the drive roller 34 and the driven rollers 35, 36, and 37, and is rotated as the drive roller 34 is driven by a motor (not shown). A large number of minute holes are formed in the conveyor belt 17, and the fans 38, 39, and 40 are disposed on the inner peripheral side of the conveyor belt 17. In addition, a recording material detection sensor 45 that detects the recording material S conveyed by the conveyor belt 17 is disposed at a position in the conveyor belt 17 facing the drive roller 34.

### Outside Air Blowing Unit

The outside air blowing unit 3100 includes four identical air units (16a, 16b, 16c, and 16d), and the air units (16a to 16d) are disposed side by side in the conveyance direction of the recording material S. The air units (16a to 16d) have fans (41a, 41b, 41c, and 41d), and the fans (41a to 41d) blow air (outside air) taken in from the outside of the casing 3010 (see FIG. 1) toward the recording material conveyance surface of the opposing conveyor belt 17. As described above, since the minute holes are formed in the conveyor belt 17, the air blown by the fans (41a to 41d) escapes from the recording material conveyance surface to the inner peripheral side and is taken in by the fans 38, 39, and 40 disposed on the inner peripheral side of the conveyor belt 17. In a state in which the recording material S is pressed against the conveyor belt 17 by blowing air, the inner peripheral surface side of the conveyor belt 17 is in a negative pressure state compared to the recording material conveyance surface side due to the intake of the fans 38, 39, and 40. Therefore, the recording material S is conveyed in a state of being stuck to the conveyor belt 17. In this way, the recording material S is stuck to the conveyor belt 17, and thus the recording material S can be stably conveyed.

In the outside air blowing unit 3100, the outside air taken in by the fans (41a to 41d) is blown without being heated, and the moisture of the ink applied to the recording material S is not dried. This is to prevent the recording material S from being deformed in a wave shape called cockling in a case where image formation by the printing module 2000 and drying of the ink by the drying module 3000 are performed at the same time on the recording material S being conveyed over the printing module 2000 and the drying module 3000.

### Drying Belt Unit

The drying belt unit 3300 includes an endless heating belt 19, a drive roller 20, driven rollers 21 and 24, heating rollers 22 and 23, temperature sensors 25 and 26, intake fans 27, 28, and 29, and an exhaust fan 47. The heating belt 19 is stretched over the drive roller 20, the driven rollers 21 and 24, and the heating rollers 22 and 23, and is rotated as the drive roller 20 is driven by a motor (not shown). A large number of minute holes are formed in the heating belt 19, and the intake fans 27, 28, and 29, the temperature sensors 25 and 26, a pressure sensor 43, and the exhaust fan 47 are disposed on the inner peripheral side of the heating belt 19.

The heating belt 19 is heated by the heating rollers 22 and 23 serving as heating portions. The heating rollers 22 and 23 are provided with roller heaters 61 and 62 therein. The roller heaters 61 and 62 are, for example, halogen heaters, and heat is generated by power supply from a control board (not shown). Here, the amount of power supplied to the roller heaters 61 and 62 is determined based on the temperature sensors 25 and 26 that measure the surface temperature of the heating belt 19. As the temperature sensors 25 and 26, for example, an infrared temperature sensor that can detect the temperature of the heating belt 19 in a non-contact manner is used. In addition, a recording material detection sensor 46 serving as a detection unit that detects the recording material S conveyed by the heating belt 19 is disposed at a position facing the drive roller 20 in the heating belt 19.

In the recording material S conveyed to the heating belt 19, high-temperature hot air is blown from the hot air blowing unit 3400 disposed above the heating belt 19 to dry the moisture of the ink. The hot air blowing unit 3400 will be described below.

As described above, since the minute holes are formed in the heating belt 19, the hot air blown from the hot air blowing unit 3400 escapes from the recording material conveyance surface to the inner peripheral side and is taken in by the intake fans 27, 28, and 29 disposed on the inner peripheral side of the conveyor belt 17. When the recording material S is pressed against the heating belt 19 by blowing hot air, the inner peripheral surface side of the heating belt 19 is in a negative pressure state compared to the recording material conveyance surface side due to the intake of the intake fans 27, 28, and 29. Therefore, the recording material S is conveyed in a state of being stuck to the heating belt 19. By sticking the recording material S to the heating belt 19 in this way, the recording material S can be stably conveyed. In addition, since the recording material S in the middle of being conveyed is heated by the heating belt 19, the drying performance of the ink is improved.

The intake fans 27, 28, and 29 are controlled such that the detection value of the pressure sensor 43 that measures the static pressure is a target value. As the intake fans 27, 28, and 29, for example, a type of fan that controls drive power by a duty ratio of an input PWM signal is used. In this case, the duty ratio of the PWM signal is fed back, and the drive power of the intake fans 27, 28, and 29 is controlled. As the pressure sensor 43, a sensor of a type that outputs a difference value between the static pressure at the location where the sensor is disposed and the atmospheric pressure. The target value of the difference value is, for example, “−1000 pascals”.

The exhaust fan 47 is provided to discharge air in the casing 3010 (in the casing) to the outside (outside the casing). During the image forming job, the exhaust fan 47 is controlled to be turned on and off such that the temperature in the casing 3010 is kept in a predetermined range (for example, 80° C. to 90° C.) higher than the normal temperature based on the detection results of the temperature sensors 25 and 26. In this manner, the drying performance of the ink during image formation is maintained. In the present embodiment, an average of the detection results of the temperature sensors 25 and 26 may be used as the temperature of the casing 3010, or the detection result of any one of the temperature sensors 25 and 26 may be used as the temperature of the casing 3010.

### Hot Air Blowing Unit

The hot air blowing unit 3400 includes three identical heat air units (18a, 18b, and 18c). The heat air units (18a to 18c) are disposed side by side in the conveyance direction of the recording material S in order to ensure the drying time of the ink and to achieve high drying performance of the ink. The heat air units (18a to 18c) will be described below with the heat air unit 18a as an example.

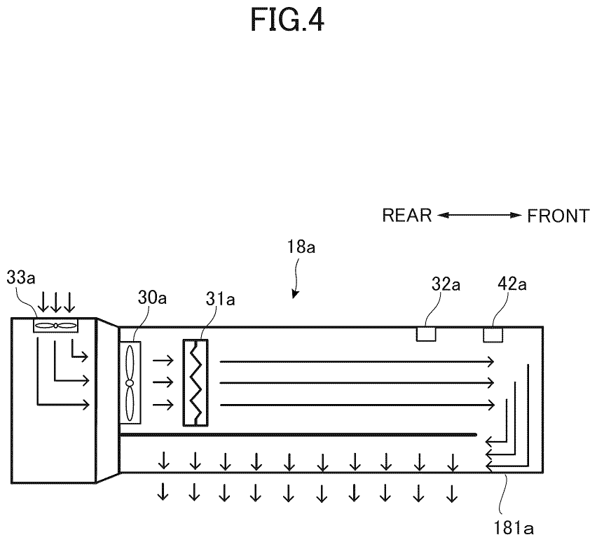

As shown in FIG. 4, the heat air unit 18a includes a blowing fan 30a, an outside air heating heater 31a, a temperature sensor 32a, an outside air fan 33a, a pressure sensor 42a, and a duct 181a. The outside air fan 33a takes air (outside air) in from the outside of the casing 3010 (see FIG. 1). The blowing fan 30a is disposed at the intake port of the duct 181a, and air taken in by the outside air fan 33a is taken into the duct 181a. The outside air heating heater 31a heats the air taken into the duct 181a by the blowing fan 30a. The temperature sensor 32a detects the temperature of the air passing through the duct 181a after the air is heated by the outside air heating heater 31a. The temperature of the outside air heating heater 31a is controlled such that the detection result of the temperature sensor 32a is a target temperature. A plurality of exhaust holes are formed in the duct 181a on a side facing the drying belt unit 3300. The air taken into the duct 181a by the blowing fan 30a is heated to a high-temperature hot air by the outside air heating heater 31a and is blown toward the recording material conveyance surface of the heating belt 19 through the exhaust holes.

The blowing fan 30a is controlled such that the detection value of the pressure sensor 42a that measures the static pressure is a target value. As the blowing fan 30a, for example, a type of fan that controls drive power by a duty ratio of an input PWM signal is used. In this case, the duty ratio of the PWM signal is fed back, and the drive power of the blowing fan 30a is controlled. The pressure sensor 42a is disposed in the flow path of the air passing through the duct 181a after heating by the outside air heating heater 31a, and outputs the difference value between the static pressure at the location where the pressure sensor 42a is disposed and the atmospheric pressure. The target value of the difference value is, for example, “500 pascals”.

### Control System of Drying Module

Next, a control system of the drying module 3000 by the control portion 900 will be described by using FIG. 5 while referring to FIGS. 1 to 3. Here, the control system of the drying belt unit 3300 and the hot air blowing unit 3400 will be mainly described. In addition, various apparatuses included in each module other than the drying module 3000 are connected to the control portion 900, but the illustration and description thereof are omitted here because the apparatuses are not the main point of the invention.

As shown in FIG. 5, the outside air fans 33a to 33c, the blowing fans 30a to 30c, the intake fans 27, 28, and 29, and the exhaust fan 47 are connected to the control portion 900, and the operation of these fans can be controlled. The outside air heating heaters 31a to 31c, the roller heaters 61 and 62, the temperature sensors 25 and 26, and the temperature sensors 32a to 32c are connected to the control portion 900. The control portion 900 can control the roller heaters 61 and 62 based on the detection results of the temperature sensors 25 and 26, and can control the outside air heating heaters 31a to 31c based on the detection results of the temperature sensors 32a to 32c.

In addition, the recording material detection sensors 45 and 46 and the drive roller 20 are connected to the control portion 900. The recording material detection sensors 45 and 46 are provided to detect a delay and an early arrival of the conveyance timing of the recording material S in the drying module 3000. The control portion 900 increases the conveyance speed of the conveyor belt 17 and the heating belt 19 in a case where the conveyance timing of the recording material S is late, and decreases the conveyance speed of the conveyor belt 17 and the heating belt 19 in a case where the conveyance timing is early. In addition, in a case where an early arrival or delay for more than a predetermined time occurs at the recording material detection sensors 45 and 46, the conveyance control of the recording material S is not operating properly, and thus the image forming operation is stopped because an error is determined.

In the present embodiment, the control portion 900 controls the exhaust fan 47 to be turned on and off such that the temperature in the casing 3010 is kept in a predetermined range (for example, 80° C. to 90° C.) during the image forming job. The control portion 900 starts (turns on) the operation of the exhaust fan 47 to lower the temperature in the casing 3010 to a predetermined range when the temperature in the casing 3010 is higher than the predetermined range, and stops (turns off) the exhaust fan 47 to raise the temperature in the casing 3010 to the predetermined range when the temperature in the casing 3010 is lower than the predetermined range. The control portion 900 operates the exhaust fan 47 with the air volume as a first air volume during the image forming job. In addition, the control portion 900 also operates the outside air fans 33a to 33c, the blowing fans 30a to 30c, and the intake fans 27, 28, and 29 at a predetermined air volume during the image forming job.

Further, the door lock portions 131, 141, and 151 and the operation unit 200 are connected to the control portion 900. The control portion 900 transmits information for changing the display content displayed on the operation unit 200 or receives various types of information, data, and the like input from the operation unit 200 by the user. In a case where the control portion 900 receives an instruction to unlock the door from the operation unit 200, the control portion 900 controls the door lock portions 131, 141, and 151 to unlock the left front door 14, the right front door 15, and the upper door 13 (see FIG. 2A). However, as will be described later, in the present embodiment, the door is not unlocked unless the temperature in the casing 3010 is equal to or lower than a predetermined temperature.

As described above, in the drying module 3000, the ink is dried by blowing hot air having a high temperature to the recording material S. In addition, the heating belt 19 is heated by the heating rollers 22 and 23. Then, during the image forming job, the temperature in the casing 3010 is kept at a high temperature (for example, in a range of 80° C. to 90° C.). As already described, in the related art, the door lock portions 131, 141, and 151 are immediately unlocked in response to the user's instruction to unlock the door, and the user can open the upper door 13, the left front door 14, and the right front door 15 (see FIG. 2A). However, when the door is unlocked immediately in response to the user's instruction to unlock the door and the user is ready to open the door, since the user opens the door without knowing that the temperature in the casing 3010 is high, there is a risk that the user will be exposed to high temperatures and may also touch various apparatuses inside the casing 3010 that have become hot. Therefore, it is preferable that the door is unlocked in a case where the temperature in the casing 3010 is equal to or lower than a predetermined temperature. The predetermined temperature may be a temperature (for example, 25° C.) at which the user does not get burned. In addition, in a case where the user performs the maintenance, when it takes time for the temperature in the casing 3010 to become equal to or lower than the predetermined temperature, the image formation cannot be performed, and the operation efficiency of the ink jet recording apparatus 100 is lowered, which is not preferable.

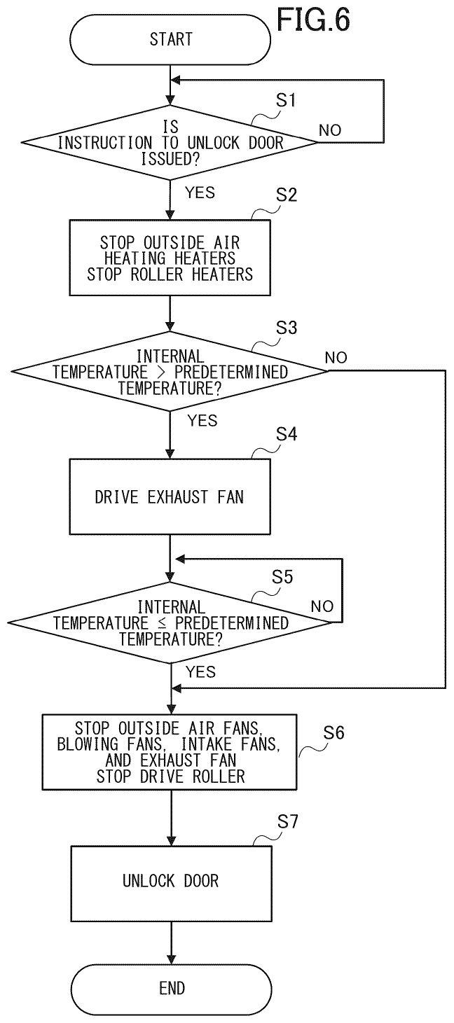

In the present embodiment, in light of the above, when the door is opened in response to the user's instruction to unlock the door, the temperature in the casing 3010 of the drying module 3000 is quickly lowered, and then the door is unlocked to be opened. In order to quickly lower the temperature in the casing 3010, the exhaust fan 47 quickly dissipates heat from the inside to the outside of the casing 3010. Hereinafter, door unlocking processing for achieving the above will be described by using FIG. 6 while referring to FIGS. 3 and 5. The control portion 900 disables the user from issuing an instruction to unlock the door from the operation unit 200 during the image formation.

### Door Unlocking Processing

As shown in FIG. 6, the control portion 900 determines whether an instruction to unlock the door is received (step S1). When an instruction to unlock the door is not received (NO in step S1), the control portion 900 waits for the processing. As described above, an instruction to unlock the door is issued by the user operating the operation unit 200, and the control portion 900 waits without unlocking the door unless the instruction to unlock the door is acquired.

When the control portion 900 receives an instruction to unlock the door (YES in step S1), the control portion 900 stops the heating of the air taken into the duct 181a by the blowing fans 30a to 30c by the outside air heating heaters 31a to 31c, and stops the heating of the heating rollers 22 and 23 by the roller heaters 61 and 62 (step S2). In addition, the control portion 900 determines whether the temperature (internal temperature) in the casing 3010 is higher than the predetermined temperature based on the detection results of the temperature sensors 25 and 26 (step S3). When the temperature in the casing 3010 is equal to or lower than the predetermined temperature (NO in step S3), the control portion 900 jumps to the processing of step S6.

When the temperature in the casing 3010 is higher than the predetermined temperature (YES in step S3), the control portion 900 drives the exhaust fan 47 (step S4). At this time, the control portion 900 starts the operation of the exhaust fan 47 when the exhaust fan 47 is stopped, and continues the operation of the exhaust fan 47 when the exhaust fan 47 is in operation. In addition, it is preferable that the control portion 900 increases the air volume of each fan compared to the air volume of each fan at the time of image formation. For example, it is preferable that the control portion 900 increases the air volume of the blowing fans 30a to 30c and the exhaust fan 47 to a second air volume larger than a first air volume during image formation. Then, the control portion 900 determines whether the temperature in the casing 3010 is equal to or lower than the predetermined temperature (for example, 25° C.) (step S5). The control portion 900 continues to discharge the air in the casing 3010 by operating the exhaust fan 47 in addition to the outside air fans 33a to 33c, the blowing fans 30a to 30c, and the intake fans 27, 28, and 29 until the temperature in the casing 3010 reaches the predetermined temperature or lower (NO in step S5).

In the present embodiment, the operations of the outside air fans 33a to 33c, the blowing fans 30a to 30c, and the intake fans 27, 28, and 29 are continued, and the rotation of the heating belt 19 is continued. As a result, the air (outside air) taken in from the outside of the casing 3010 is blown to cool the heating belt 19 without being heated by the outside air heating heaters 31a to 31c. In addition, the air (outside air) taken in from the outside of the casing 3010 cools not only the heating belt 19 but also each part of the drying belt unit 3300 and the hot air blowing unit 3400. In addition, since the exhaust fan 47 promotes the discharge of air from the inside to the outside of the casing 3010, heat can be quickly dissipated from the inside to the outside of the casing 3010, and the temperature in the casing 3010 can be quickly lowered.

When the control portion 900 receives an instruction to unlock the door, it is preferable that the control portion 900 drives the outside air fans 33a to 33c, the blowing fans 30a to 30c, the intake fans 27, 28, and 29, and the exhaust fan 47 with a predetermined control amount such that the air volume thereof is increased as compared with the air volume during image formation. The predetermined control amount is, for example, a duty ratio of a PWM signal that controls the supply power of each fan. The duty ratio is a predetermined value and may be, for example, 50% or 100%.

When the temperature in the casing 3010 is lowered to the predetermined temperature or lower (YES in step S5), the control portion 900 stops the exhaust fan 47 (step S6). In addition, the control portion 900 stops the outside air fans 33a to 33c, the blowing fans 30a to 30c, and the intake fans 27, 28, and 29, and further stops the drive roller 20 (step S6). After the above-described fans are stopped, the control portion 900 controls the door lock portions 131, 141, and 151 to unlock the left front door 14, the right front door 15, and the upper door 13 (see FIG. 2A) (step S7).

As described above, in the present embodiment, in a case where an instruction to unlock the door is issued, the temperature in the casing 3010 is lowered to a predetermined temperature or lower that is safe for the user by the exhaust fan 47. Then, the door is unlocked by the door lock portions 131, 141, and 151, and the door can be opened. As described above, in the present embodiment, since the user cannot immediately open the door in response to the instruction to unlock the door until the temperature in the casing 3010 is lowered to the predetermined temperature or lower, the door will not be opened while the inside of the casing 3010 is at a high temperature.

In addition, since the exhaust fan 47 forcibly discharges the air in the casing 3010 to the outside of the casing 3010 by using the air (outside air) blown from the blowing fans 30a to 30c to the heating belt 19, the time required for the temperature in the casing 3010 to be lowered to a predetermined temperature or lower can be shortened. As a result, the present invention contributes to improvement of the operation efficiency of the ink jet recording apparatus 100.

In the present embodiment, the temperature sensors 25 and 26 detect the temperature of the heating belt 19, and the door is unlocked when the temperature of the heating belt 19 is equal to or lower than a predetermined temperature. This is because, in a case where the user accesses the inside of the casing, the user may touch the heating belt 19 having a high temperature. Since the heating belt 19 becomes hot and the user is also likely to touch the heating belt 19, the temperature sensors 25 and 26 that detect the temperature of the heating belt 19 are used as a trigger for unlocking.

### Second Embodiment

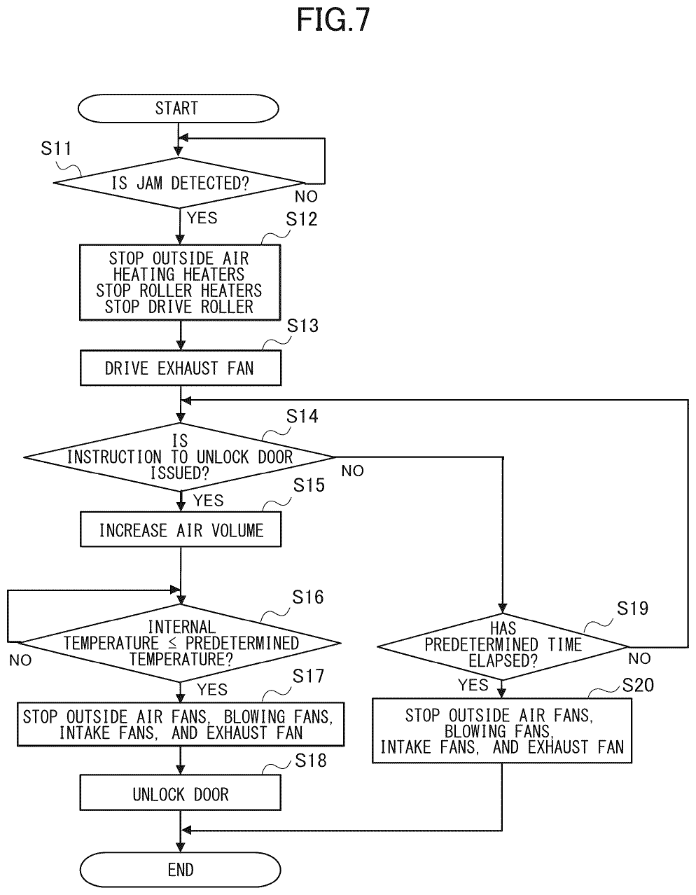

Next, a second embodiment will be described. As described above, in a case where a jam occurs in which the recording material S is clogged in the middle of being conveyed, the user can remove the recording material S by opening the upper door 13, the left front door 14, and the right front door 15. Even in a case where a jam occurs, when the door is unlocked immediately in response to the user's instruction to unlock the door, there is a risk that the user will open the door without knowing that the temperature in the casing 3010 is high. Therefore, even in a case where a jam occurs, it is preferable that the door is unlocked in a case where the temperature in the casing 3010 is equal to or lower than the predetermined temperature. Hereinafter, door unlocking processing in a case where a jam occurs will be described by using FIG. 7 while referring to FIGS. 3 and 5.

The control portion 900 determines whether a jam has occurred in which the recording material S is clogged in the middle of being conveyed, based on the detection results of the recording material detection sensors 45 and 46 (step S11). When a jam occurs (YES in step S11), the control portion 900 controls the drive roller 20 to stop the rotation to stop the conveyance of the recording material S by the heating belt 19, and controls the outside air heating heaters 31a to 31c and the roller heaters 61 and 62 to stop the heating of the heating belt 19 (step S12). Then, the control portion 900 drives the exhaust fan 47 (step S13). In this case, the control portion 900 starts the operation of the exhaust fan 47 when the exhaust fan 47 is stopped, and continues the operation of the exhaust fan 47 when the exhaust fan 47 is in operation. In addition, it is preferable that the control portion 900 increases the air volume of each fan compared to the air volume of each fan during image formation. For example, it is preferable that the control portion 900 increases the air volume of the blowing fans 30a to 30c and the exhaust fan 47 to a second air volume larger than a first air volume during image formation.

The control portion 900 determines whether an instruction to unlock the door is received (step S14). When an instruction to unlock the door is not acquired (NO in step S14), the control portion 900 determines whether a predetermined time has elapsed from the detection of a jam (step S19). When a predetermined time has not elapsed from the detection of a jam (NO in step S19), the control portion 900 returns to the processing of step S14. When a predetermined time has elapsed from the detection of a jam (YES in step S19), the control portion 900 stops the outside air fans 33a to 33c, the blowing fans 30a to 30c, the intake fans 27, 28, and 29, and the exhaust fan 47 (step S20).

In this case, since the heating by the outside air heating heaters 31a to 31c and the roller heaters 61 and 62 is stopped and the exhaust fan 47 is driven, the temperature in the casing 3010 is lowered with the passage of time. Then, after a predetermined time elapses from the detection of a jam, the temperature in the casing 3010 is lowered to a predetermined temperature or lower that is safe for the user. The predetermined time here is a time sufficient for the temperature in the casing 3010 to drop to the predetermined temperature or lower, and is stored in advance in the ROM or the like. In this case, since an instruction to unlock the door is not acquired, the control portion 900 does not unlock the door. However, in a case where the user issues an instruction to unlock the door later, the temperature in the casing 3010 has already been lowered to a predetermined temperature or lower, and thus the door is immediately unlocked.

Meanwhile, when an instruction to unlock the door is received (YES in step S14), the control portion 900 increases the air volume of each fan as compared with the air volume of each fan during image formation (step S15). For example, the control portion 900 increases the air volume of the blowing fans 30a to 30c and the exhaust fan 47 to a second air volume larger than a first air volume during image formation. Then, the control portion 900 determines whether the temperature in the casing 3010 is equal to or lower than the predetermined temperature (for example, 25° C.) (step S16). The control portion 900 operates the exhaust fan 47 in addition to the outside air fans 33a to 33c, the blowing fans 30a to 30c, and the intake fans 27, 28, and 29 until the temperature in the casing 3010 reaches the predetermined temperature or lower, and continues to discharge the air in the casing 3010 (NO in step S16). When the temperature in the casing 3010 is lowered to the predetermined temperature or lower (YES in step S16), the control portion 900 stops the outside air fans 33a to 33c, the blowing fans 30a to 30c, the intake fans 27, 28, and 29, and the exhaust fan 47 (step S17). After the above-described fans are stopped, the control portion 900 controls the door lock portions 131, 141, and 151 to unlock the left front door 14, the right front door 15, and the upper door 13 (see FIG. 2A) (step S18).

As described above, in a case where a jam occurs, the exhaust fan 47 is driven after the heating by the outside air heating heaters 31a to 31c and the roller heaters 61 and 62 is stopped. In a case where an instruction to unlock the door is issued, the door is not unlocked by the door lock portions 131, 141, and 151 unless the temperature in the casing 3010 is lowered to a predetermined temperature or lower that is safe for the user by the exhaust fan 47. Therefore, even in a case where a jam occurs, the user cannot immediately open the door in response to the instruction to unlock the door until the temperature in the casing 3010 is lowered to the predetermined temperature or lower, and thus the door will not be opened while the inside of the casing 3010 is at a high temperature.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-035942, filed Mar. 8, 2024, which is hereby incorporated by reference herein in its entirety.

What is claimed is:

1. An ink jet recording apparatus forming an image on a recording material by jetting an ink, the apparatus comprising:
a conveyance portion configured to convey the recording material on which the image is formed by the ink;
a drying portion including a heater and a blowing fan blowing air toward the conveyance portion and configured to dry the ink by blowing air heated by the heater to the recording material conveyed by the conveyance portion;
a casing configured to accommodate the conveyance portion;
a temperature sensor configured to detect a temperature in the casing;
an exhaust fan configured to exhaust air in the casing to an outside of the casing and to be controlled to an operation state and a stop state based on a detection result of the temperature sensor;
a door provided to be opened and closed on the casing to allow access to the conveyance portion;
a lock mechanism configured to lock the door to the casing in a closed state; and
a control portion configured to control the drying portion, the lock mechanism, and the exhaust fan,
wherein, in a case where the control portion receives an instruction to unlock the door locked by the lock mechanism, the control portion is configured to stop heating of the air by the heater,
start an operation of the exhaust fan when the exhaust fan is stopped,
continue the operation of the exhaust fan when the exhaust fan is in operation, and
unlock the door locked by the lock mechanism after the temperature in the casing reaches a predetermined temperature or lower.

2. The ink jet recording apparatus according to claim 1, wherein
the exhaust fan is operable at a first air volume and a second air volume larger than the first air volume, and
in a case where the control portion receives the instruction to unlock the door, the control portion is configured to start the operation of the exhaust fan at the second air volume when the exhaust fan is stopped, and change an air volume of the exhaust fan to the second air volume when the exhaust fan is in operation at the first air volume.

3. The ink jet recording apparatus according to claim 1, wherein
the blowing fan is operable at a first air volume and a second air volume larger than the first air volume, and
in a case where the control portion receives the instruction to unlock the door, the control portion is configured to change an air volume of the blowing fan from the first air volume to the second air volume.

4. The ink jet recording apparatus according to claim 1, wherein
the control portion is configured to operate the exhaust fan and the blowing fan until the temperature in the casing reaches the predetermined temperature or lower.

5. The ink jet recording apparatus according to claim 1, wherein
the door is an upper door that is provided above the casing to be opened and closed in an up-down direction with respect to the casing, and
the drying portion is disposed on the upper door and moves together with the upper door to be accessible from above to the conveyance portion accommodated in the casing.

6. The ink jet recording apparatus according to claim 1, wherein
the door is a front door that is provided to be opened and closed in a direction intersecting an up-down direction with respect to the casing, and
the conveyance portion is in an accessible state in a state in which the front door is opened.

7. An ink jet recording apparatus forming an image on a recording material by jetting an ink, the apparatus comprising:
a conveyance portion configured to convey the recording material on which the image is formed by the ink;
a detection unit configured to detect the recording material conveyed by the conveyance portion;
a drying portion including a heater and a blowing fan blowing air toward the conveyance portion and configured to dry the ink by blowing air heated by the heater to the recording material conveyed by the conveyance portion;
a casing configured to accommodate the conveyance portion;
a temperature sensor configured to detect a temperature in the casing;
an exhaust fan configured to exhaust air in the casing to an outside of the casing and to be controlled to an operation state and a stop state based on a detection result of the temperature sensor;
a door that is provided to be opened and closed on the casing to allow access to the conveyance portion;
a lock mechanism configured to lock the door to the casing in a closed state; and
a control portion configured to control the drying portion, the lock mechanism, and the exhaust fan,
wherein, in a case where an error occurs in a detection result of the detection unit, the control portion is configured to stop heating of the air by the heater, and start the operation of the exhaust fan when the exhaust fan is stopped, and
wherein when the control portion receives an instruction to unlock the door locked by the lock mechanism after the error occurs, the control portion is configured to unlock the door locked by the lock mechanism after the temperature in the casing reaches a predetermined temperature or lower.

8. The ink jet recording apparatus according to claim 7, wherein
the exhaust fan is operable at a first air volume and a second air volume larger than the first air volume, and
in a case where the control portion receives the instruction to unlock the door, the control portion is configured to change an air volume of the exhaust fan from the first air volume to the second air volume.

9. The ink jet recording apparatus according to claim 7, wherein
the blowing fan is operable at a first air volume and a second air volume larger than the first air volume, and
in a case where the control portion receives the instruction to unlock the door, the control portion is configured to change an air volume of the blowing fan from the first air volume to the second air volume.

10. The ink jet recording apparatus according to claim 7, wherein
the control portion is configured to operate the exhaust fan and the blowing fan until the temperature in the casing reaches the predetermined temperature or lower.

11. The ink jet recording apparatus according to claim 7, wherein
the door is an upper door that is provided above the casing to be opened and closed in an up-down direction with respect to the casing, and
the drying portion is disposed on the upper door and moves together with the upper door to be accessible from above to the conveyance portion accommodated in the casing.

12. The ink jet recording apparatus according to claim 7, wherein
the door is a front door that is provided to be opened and closed in a direction intersecting an up-down direction with respect to the casing, and
the conveyance portion is in an accessible state in a state in which the front door is opened.

13. The ink jet recording apparatus according to claim 1, wherein
the conveyance portion includes a belt that rotates to convey the recording material, and a heating portion that heats the belt, and
the temperature sensor is configured to detect a temperature of the belt.
